(19) United States
(12) Patent Application Publication
(10) Pub. No.: US 2005/0274027 A1
(43) Pub. Date: Dec. 15, 2005

(54) Punch tool for layflat hose

(76) Inventor: Mordechai Eldar, Or Yehuda (IL)

Correspondence Address: OSTROLENK FABER GERB & SOFFEN, 1180 AVENUE OF THE AMERICAS, NEW YORK, NY, 100368403, US

(21) Appl. No.: 11/137,815

(22) Filed: May 24, 2005

(30) Foreign Application Priority Data
Jun. 13, 2004 (IL) 162538

(51) Int. Cl. B24B 23/00

(52) U.S. Cl. 30/363

(57) ABSTRACT

A cutting tool for forming a hole in the wall of a plastic pipe has a body portion defined by a rear grasp portion and by a frontal portion. The frontal portion is provided at one end with a through going vertical passage which accommodates the cutting element therein and guides the cutting element. A frontal portion of the body has a mounting pin and the body has an upper compartment with a spring. A pressure handle enables pivotal displacement thereof between an erected position and a depressed position which enables forceable displacement of the cutting element from an uppermost position to a lowermost position and vice versa.

### BACKGROUND OF THE INVENTION

In irrigation of agricultural fields, one of the types of piping, that is relatively new, and becoming popular, is the layflat hose. It's primary advantage is its flexibility, similar to fire-hose, but made out of composite plastic material containing reinforcing fibers. When there is no water flowing through the hose, the hose is flat, but when water flows the hose blows up and becomes round. This type of piping is the main pipeline onto which smaller pipes are attached to bring the water to the plants. The wall thickness of this hose is between 1 mm and 2.5 mm. In comparison to the regular irrigation piping made of polyethelene, the hole making in the layflat hose is problematic because of the flexibility of the hose. Available tools, including a tool manufactured by myself, for which was registered a design patent no: 27236, are not efficient for punching layflat hoses, since a great amount of effort is needed in order to perforate the layflat hose. The present invention concerns new tool, for which I am requesting a patent. The new tool is defined by a cutting member with special cutting geometry of the cutting edges that ensure an easy cut in this layflat hose. The new tool is also provided with a mechanical connection between the handle and the pushing element, and by virtue of this provision the blade can be extricated from the hose in case of catching in dirt or in the fibers of the hose during the holing process when, in this case, the spring coil does not have sufficient strength to return the cutting member to its resting position. This is the progressive invention of extreme benefit for which I am applying for a patent.

### BRIEF DESCRIPTION OF THE DRAWINGS

FIG. 1a: is an isometric presentation of the tool of the present invention during punching of the layflat hose.

FIG. 1b: presents layflat hose with punched holes.

FIG. 2a: is a front view of the tool of the invention.

FIG. 2b: is a bottom view of the tool of the invention.

FIG. 2c: is an upper view of the tool of the invention.

FIG. 2d: is a left side view of the tool of the invention.

FIG. 2e: is a cross-sectional view of the tool presented in FIG. 2a along direction E-E.

FIG. 2f: is a cross-sectional view of the tool presented in FIG. 2d along direction F-F.

FIG. 3: is an exploded view of the tool of the invention.

FIGS. 4a,b: are cross-sectional views of a tubular cutter known in the art.

FIG. 4c-e: show schematically how layflat hose is being cut.

FIGS. 5a,b: show schematically how cutting element employed in the tool of the invention is manufactured.

FIGS. 5c,d: are side views and cross-sections of the cutting element of the invention.

FIGS. 6a,b: show how cutting element of the invention punches layflat hose.

FIG. 6c: is an isometric view of the cutting element of the invention.

### DETAILED DESCRIPTION OF THE INVENTION

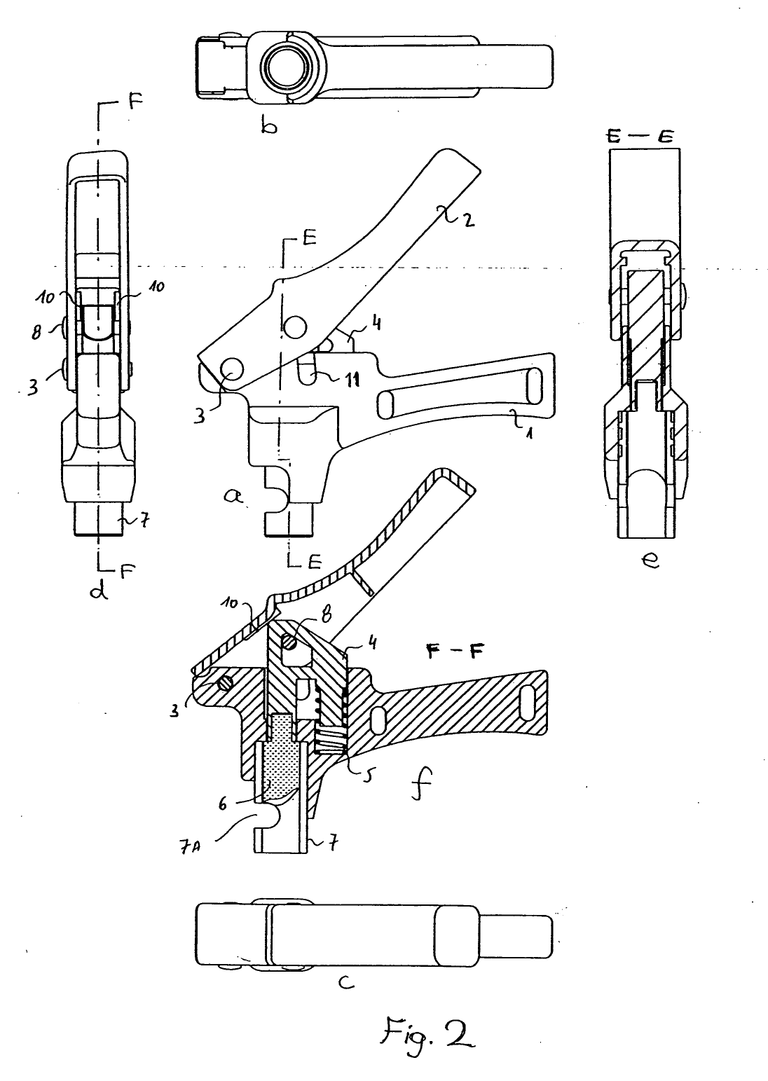

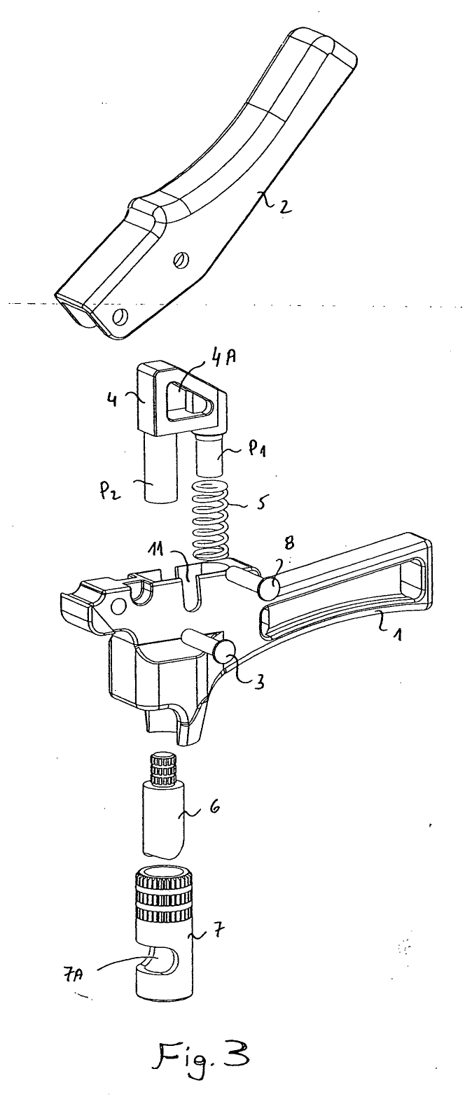

With reference to FIGS. 2, 3 it will be explained now the construction of the punching tool of the present invention. The punching tool of the invention comprises the following main elements:

The body (1) of the tool.

The handle (2) of the tool.

Holding pin (3) which pivotally connects the body with the handle.

Pushing element (4) provided with a through going window (4a).

Spring coil (5).

Guiding member (7) fitted with cutting element (6).

Access window (7a) of the guiding member member.

Pin (8) that provides connection between the pushing element (4) and the handle (2).

All the parts of the tool are made of hard plastic material, apart from the spring coil made of steel, and the blade and cylindrical guiding portion made of hardened and sharpened steel.

Below is a short summary of how the tool operates:

To a body (1) of the tool is pivotally attached a handle (2) by means of a holding pin (3). When the handle (2) is pushed in the direction of the body (1) of the tool, a lever action is precipitated that pushes down on the pushing element (4) that pushes a cutting element (6) in a downward motion to cut a layflat hose (9) that is received within access window (7a) provided in the guiding memebr (7). The guiding member is situated within the lower part of the body (1) of the tool. The window (7a) of the guiding member receives the hose (9) therein to expose it to the punching action performed by the cutting element (6), when it displaces along the guiding member (7) it is not explained in details, but should be appreciated that the cutting element (6) has its outside diameter fitting to the inside diameter of the guiding member (7) to enable guiding. The cutting element (6) is secured within the pushing element (4). The pushing element (4) that is shaped as an upside down U, sits appropriately inside frontal portion of the tool body (1) and has freedom of linear reciprocative movement The right side of the pushing element (4) is provided with a protrusion P1 along which extends the spring coil (5) that forcibly returns the pushing element (4) to its' resting position at the end of the cutting action. The pushing element is also provided with a second protrusion P2, which extends parallel to the protrusion P1. This protrusion is intended for connecting with the cutting element. On the underside of the handle (2) there are two protrusions (10) that ensure that the pushing element (4) retains its correct position within the handle (2). During the cutting action, the pin (8) that passes through a window (4a) made in the pushing element (4) is free to move downward along the hollow (11) provided in the upper part of the body of the tool. In the event that the cutting element (6) is caught in the fibers of the hose (9) it is possible to release the cutting element (6) and forcibly return it back up to its resting position pulling the handle (2), which displaces the pushing element (4) up by virtue of the pin (8). The waste plastic (12) falls out of the tool and out of the hose (9). The possibility to return the blocked cutting element (6) is one of the novelties of the punching tool of the invention. The other novelty of the tool lies in the special geometry of the cutting element.

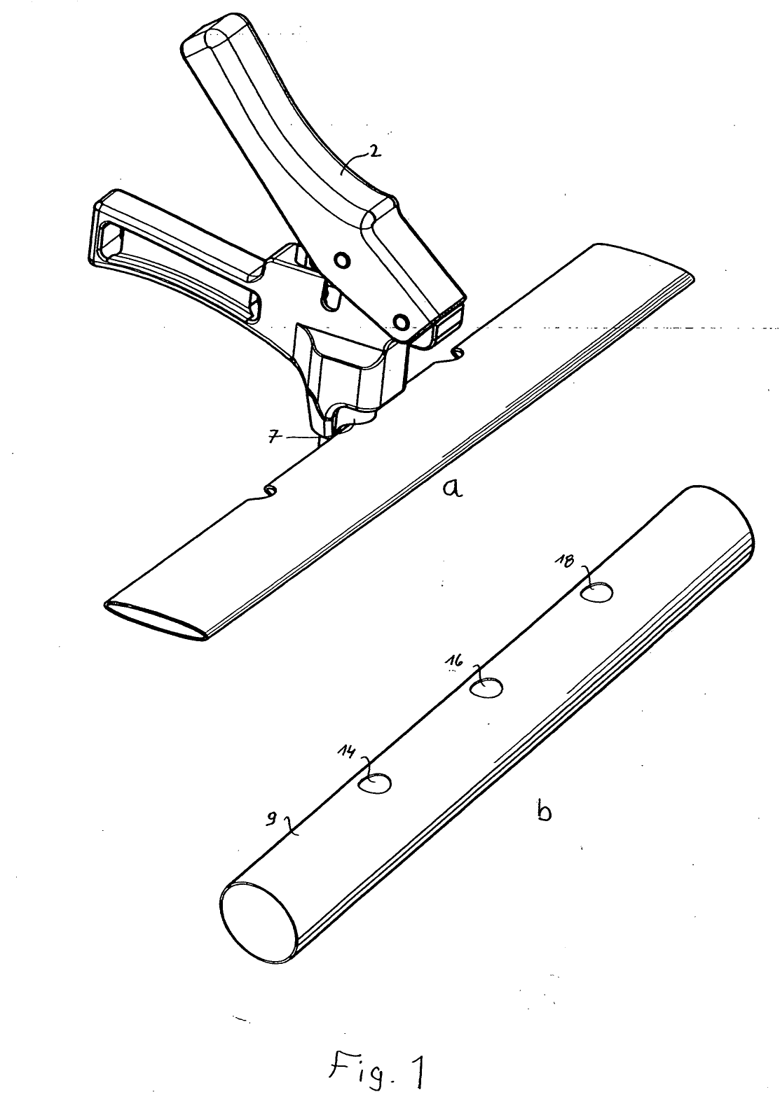

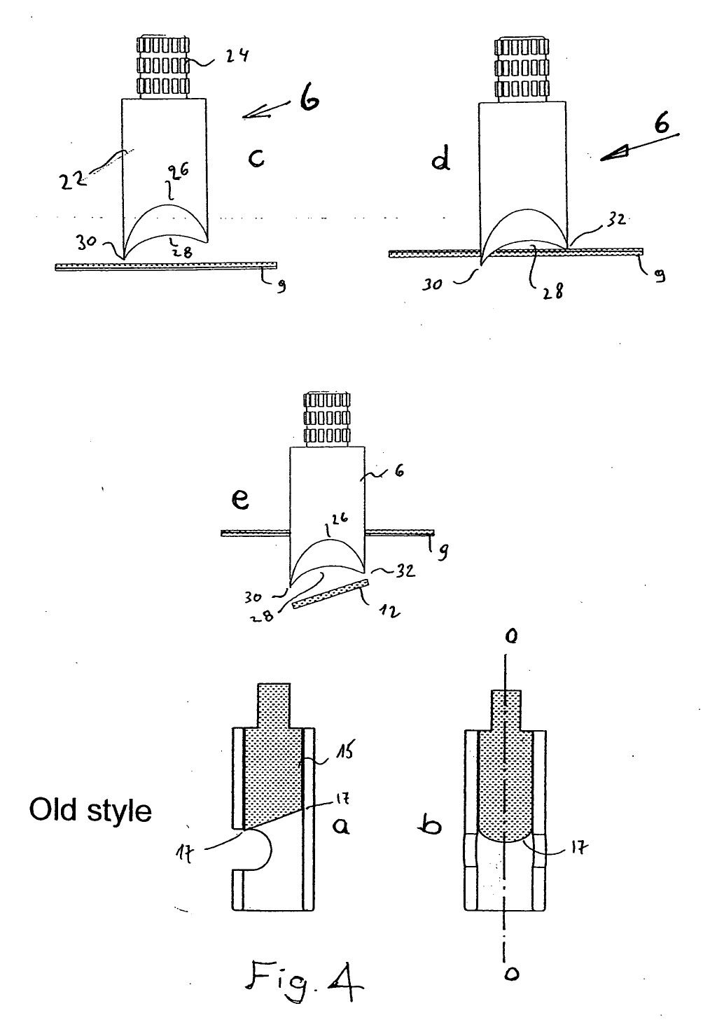

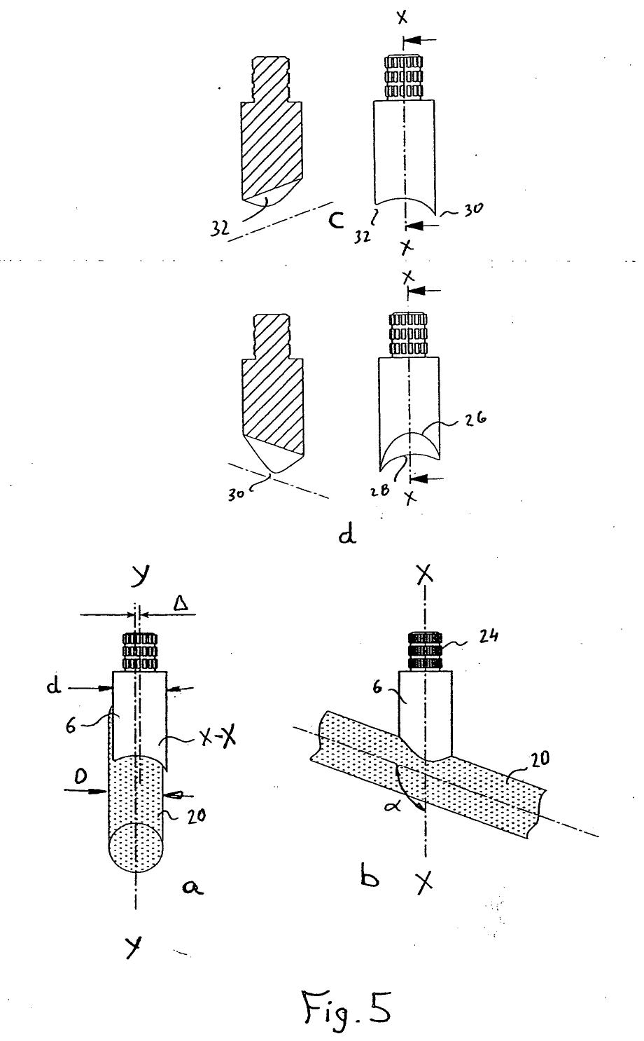

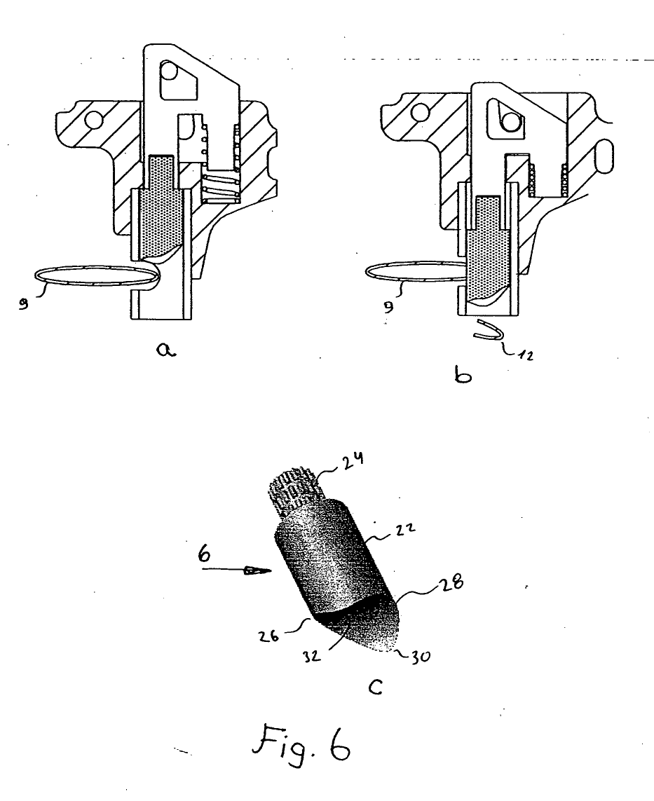

With reference to FIGS. 1, 4, 5, 6, it will be explained geometry of the new cutting element (6) employed in the cutter tool of the present invention. This cutting element (6) is provided with a body portion (22) fitted with a neck portion (24) for accommodating within appropriate bore provided in the second protrusion P2 of the pushing element. The cutting element (6) is provided with new cutting geometry which enables the holing of layflat hose (9) as described in FIG. 1. It can be seen that the folded layflat hose (9) is positioned in the window (7a) of the guiding member (7), and when pressure is exerted on the handle (2), the cutting element (6) moves downwards along the guiding member (7), penetrating into the hose (9) and thereby creating holes (14, 16, 18) in the hose (9). The special geometry of cutting edges of the cutting element (6), according to the present invention, that shall be described forthwith, ascertains the holing of the layflat hose (9) is effected in the most efficient and effortless way possible. The cutting element (15), as know in the art till now, is depicted in FIG. 4. This cutting element has cutting edges (17) which are arched with their center laying on the longitudinal axis (o-o) of the cutting element. The new cutting element (6) as described in FIG. 4:c,d,e, and FIG. 5 has such geometry that its' cutting edges are not symmetrical in relation to the longitudinal axis (x-x) of the cutting element (6). Now with reference to FIG. 5: a, b, it will be explained how this geometry is obtained. The new cutting element (6) is manufactured from blank that is either a hollow tube or a solid rod by virtue of the milling action. The milling action is effected in such a manner, that the rotational axis (y-y) of the milling cutter (20) crosses with the axis (x-x) but does not pass through it. The milling process is executed by a milling cutter (20) which has an outer diameter D equal to, or less than, the outer diameter d of the blank for the cutting element (6). It can be seen in FIG. 5a, that the axis (y-y) of the milling cutter (20) and axis (x-x) of the blank, are linearly displaced so that a distance (Δ) is created between them. In practice this distance is approximately 1 mm. In FIG. 5b can also be seen that the rotational axis (y-y) of the milling cutter (20) is angularly displaced with respect to longitudinal axis (x-x) of the blank by an angle (α). In practice this angle is up to 110 degrees. Thus the arched cutting edges are created, which are a-symmetrical in relation to axis (x-x). In FIG. 5: c, d, and FIG. 6c can be seen the working end of the cutting element (6) featuring its' arched back edge (26) and its' arched front cutting edge (28), its' arched lower cutting edge (30) and its' arched upper cutting edge (32). It can also be seen that the cutting edge (30) is situated lower than cutting edge (32) so that during the cutting action the cutting edge (30) first meets with the hose material (9) and penetrates it, and only after this, the upper cutting edge (32) also meets with the hose material (9). This cutting action is described in FIGS. 4c,d,e. In FIG. 4c the cutting edge (30) of the cutting element (6) is seen to almost reach the hose (9) and is ready to penetrate it. In FIG. 4d, the lower cutting edge (30) is seen already penetrated through the hose (9) and the upper cutting edge (32) approaching and ready to penetrate it. In FIG. 4e, the whole cutting element (6) can be seen to have penetrated the hose (9), the upper and lower cutting edges (30+32) penetrated through the hose (9) and waste plastic (12) has been created, After the extraction of the waste plastic (12), which is a half-circle shape, due to the fact that the hose (9) is folded, the circular hole created in the hose (9). The hose with circular holes 14, 16, 18 is seen in FIG. 1b. At the completion of the holing process, the cutting element (6) is released from the hose (9) by virtue of the spring coil (5) pulling the element (4) and the cutting element (6) up. It should be noted that the cutting action is executed easily by virtue of the fact that the cutting edges do not simultaneously penetrate the hose (9), thus the pressure exerted on one cutting edge is greater that the pressure which would be applied on two cutting edges simultaneously. It should be appreciated that features disclosed in the foregoing description, and/or in the foregoing drawings, and/or examples, and/or following claims both separately and in any combination thereof, be material for realizing the present invention in diverse forms thereof.

1. A cutting tool for forming a hole in a wall of plastic lay flat pipe by virtue of a cutting element, capable to penetrate through the wall upon applying a force thereon, the said tool comprises
a) a body portion defined by a rear grasp portion and by a frontal portion, said frontal portion is provided at its upper extremity with a through going vertical passage, said passage is adapted for accommodating the cutting element therein and for guiding the cutting element there along from an uppermost position to a lowermost position; the frontal portion of the body portion is provided with a mounting pin, said body portion is provided with an upper compartment for deployment therein a pushing member and a spring means,
b) a pressure handle connected by the mounting pin to the body portion so as to enable pivotal displacement of the pressure handle between an erected position and a depressed position, wherein said pivotal displacement of the pressure handle entails forcible displacement of the cutting element from the uppermost position to the lowermost position or vice versa.

2. The cutting tool as defined in claim 1, in which said pushing member is connected to the pressure handle and to the cutting element with possibility to push the cutting element down when the pressure handle is displaced from the erected position to the depressed position or to forcibly pull the cutting element up when the pressure handle is displaced from the depressed position to the erected position.

3. The cutting tool as defined in claim 2, in which said pressure handle is provided with an auxiliary mounting pin and said pushing member is provided with a window, wherein said auxiliary pin passes through the said window to ensure that the pressure member is forcibly pulled up by the pressure handle when it displaces from the depressed position to the erected position.

4. The cutting tool as defined in claim 2, in which said cutting element is detachably connected to the pushing member.

5. The cutting tool as defined in claim 1, in which said vertical passage is provided with an access window for receiving the pipe there-into.

6. A cutting element for use with a cutting tool for forming a hole in a lay flat plastic pipe, said cutting element is capable to penetrate through the wall upon applying a force thereon, the said element comprises a body portion provided with a working end, said working end is defined by an upper arched cutting edge, by a lower arched cutting edge, by a front arched cutting edge and by a rear arched edge, wherein neither of said arched edges is symmetrical with respect to a central longitudinal axis of the body portion.

7. A cutting element as defined in claim 6, in which at least said working end of the cutting element is hollow.

8. A cutting element as defined in claim 6, in which the body portion of the cutting element is solid.

9. A method for manufacturing a cutting element suitable for forming a hole in a lay flat plastic pipe, said method comprising:
providing an elongated blank having a longitudinal central axis X-X and an outside diameter d
providing a milling cutter rotating around a longitudinal central axis Y-Y and having an outside diameter D, which is is less or equal to d,
displacing the milling cutter with respect to the blank in such a manner that the central axis X-X remains parallel to the axis Y-Y and remote there-from by a distance Δ, wherein said axis X-X crosses the axis Y-Y at an angle α, and
milling the blank so as to manufacture cutting element having its working end provided with an arched lower cutting edge, an arched upper cutting edge, a front arched cutting edge and a rear arched edge, wherein none of the edges is symmetrical with respect to the axis x-x.
